(19) United States
(12) Patent Application Publication
(10) Pub. No.: US 2012/0254572 A1
(43) Pub. Date: Oct. 4, 2012

(54) INFORMATION TERMINAL AND SECURITY MANAGEMENT METHOD

(76) Inventor: TOSHIYUKI HIROTA, Tokyo (JP)

(21) Appl. No.: 13/366,004

(22) Filed: Feb. 3, 2012

(30) Foreign Application Priority Data
Mar. 31, 2011 (JP) 2011-080106

(51) Int. Cl. G06F 12/14

(52) U.S. Cl. 711/163; 711/E12.091

(57) ABSTRACT

An information terminal of an embodiment has a communication section, a nonvolatile storage medium and a control section. The communication section performs transmission and reception with a predetermined server via the Internet. The nonvolatile storage medium stores information about a last date and time when an operating system is logged into. When the communication section receives a special command from the predetermined server, the control section performs control to transmit the information about the last date and time when the operating system is logged into, which is stored in the nonvolatile storage medium, to the predetermined server via the Internet.

### CROSS-REFERENCE TO RELATED APPLICATION

This application is based upon and claims the benefit of priority from the prior Japanese Patent Application No. 2011-80106 filed on Mar. 31, 2011; the entire contents of which are incorporated herein by reference.

### FIELD

An embodiment described herein relates generally to an information terminal and a security management method.

### BACKGROUND

Recently, with the wide spread of information terminals such as notebook personal computers and mobile phone terminals, there is a demand for appropriate protection of information handled by the information terminals. When any misuse is performed, quick investigation into the cause is essential to prevent damage from spreading and to take preventive measures.

Therefore, an information terminal is provided with a mechanism for disabling use of the information terminal in order to prevent access to a file or the like related to confidential matters which is stored in the information terminal when a rightful owner has lost the information terminal or the information terminal is stolen.

Furthermore, such an information terminal is provided with a mechanism for, when the information terminal is lost or stolen, constructing a log of data which has been accessed recently and transmitting the log to an address of the rightful owner before disabling use of the information terminal. Thereby, the rightful owner can clearly know whether the file or the like related to the confidential matters has been accessed or not.

However, when the information terminal is lost or stolen, only the information about whether the confidential file has been accessed or not is not sufficient. For example, if a hard disk drive (hereinafter referred to as an HDD) is removed from the information terminal, there is a strong possibility that a file access history cannot be accurately held. There is also a possibility that a malicious act other than file access is performed against the information terminal.

### BRIEF DESCRIPTION OF THE DRAWINGS

FIG. 1 is a diagram showing a configuration of an information terminal which implements a security management method according to an embodiment of the present invention;

FIG. 2 is a diagram showing a detailed configuration of the information terminal according to the embodiment of the present invention;

FIG. 3 is a diagram showing an example of a configuration for detecting removal/insertion of an HDD 13;

FIG. 4 is a diagram showing an example of another configuration for detecting removal/insertion of an HDD 13; and

FIG. 5 is a diagram for illustrating the security management method using the information terminal.

### DETAILED DESCRIPTION

An information terminal of an embodiment has a communication section, a nonvolatile storage medium and a control section. The communication section performs transmission and reception with a predetermined server via the Internet. The nonvolatile storage medium stores information about a last date and time when an operating system is logged into. When the communication section receives a special command from the predetermined server, the control section performs control to transmit the information about the last date and time when the operating system is logged into, which is stored in the nonvolatile storage medium, to the predetermined server via the Internet.

The embodiment of the present invention will be described in detail below with reference to drawings.

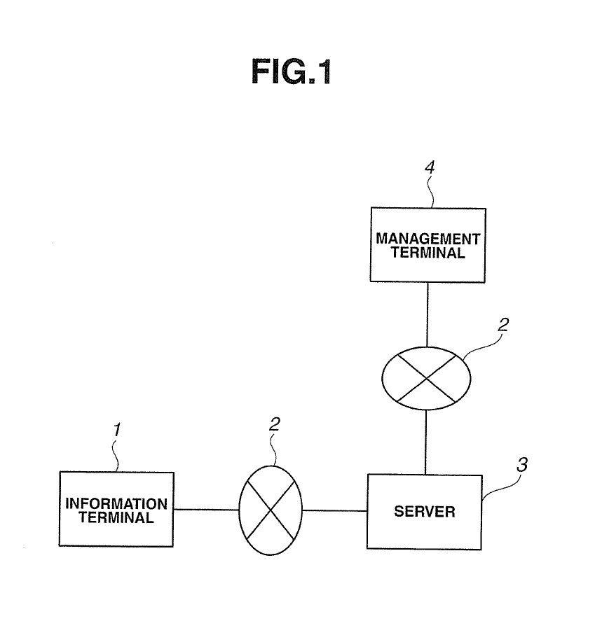

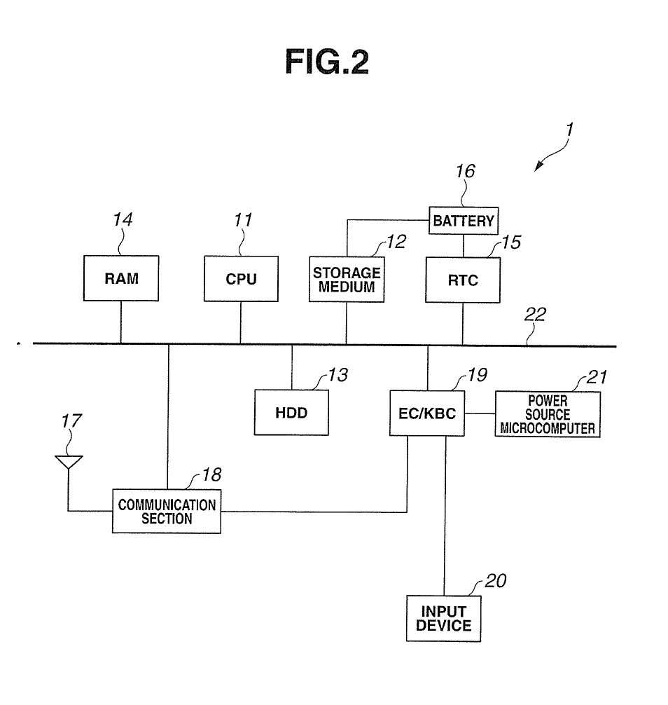

First, a configuration of the information terminal which implements a security management method according to the embodiment of the present invention will be described on the basis of FIGS. 1 and 2.

FIG. 1 is a diagram showing the configuration of the information terminal which implements the security management method according to the embodiment of the present invention, and FIG. 2 is a diagram showing a detailed configuration of the information terminal according to the embodiment of the present invention.

As shown in FIG. 1, an information terminal 1 is a notebook personal computer (hereinafter referred to as a notebook PC) and connected to a server 3 via the Internet 2. The information terminal 1 and the server 3 can mutually transmit and receive a short message service (hereinafter referred to as an SMS) via the Internet 2.

The information terminal 1 is not limited to a notebook PC and may be a desktop personal computer, a mobile phone terminal or the like. Information transmission and reception by the information terminal 1 and the server 3 is not limited to use of an SMS but may be performed, for example, with the use of an e-mail or the like.

The server 3 is connected to a management terminal 4 via the Internet 2. The management terminal 4 is a computer installed in a management company or the like which performs security management of the information terminal 1 in response to a request from a rightful owner of the information terminal 1. The management terminal 4 can make settings for a state of loss of the information terminal 1 in the server 3 via the Internet 2. In the loss state settings, deletion of data stored in an HDD to be described later, lock of the information terminal 1 and the like are set. When the loss state settings are instructed, the server 3 instructs the information terminal 1 to make the loss state settings using an SMS.

When the loss state settings are made, the information terminal 1 notifies the result to the server 3. In this case, the information terminal 1 transmits state-after-loss information about the information terminal 1, to the server 3 in addition to the result notification to write the state-after-loss information in the server 3. The state-after-loss information is information about a date and time when an operating system (hereinafter referred to as an OS) is logged into last, a date and time when OS login is attempted last, a date and time when a BIOS (basic input/output system) password is cleared last, a date and time when a BIOS password is inputted last, a date and time when the HDD is removed/inserted last, and a remaining battery level.

The management terminal 4 can read out the state-after-loss information about the information terminal 1 written in the server 3, via the Internet 2. The read-out state-after-loss information about the information terminal 1 is notified to the rightful owner of the information terminal 1 by an administrator who handles the management terminal 4.

Next, the detailed configuration of the information terminal 1 will be described with the use of FIG. 2.

As shown FIG. 2, the information terminal 1 is configured to have a central processing unit (hereinafter referred to as a CPU) 11, a storage medium 12, an HDD 13, an RMA 14, a real time clock (hereinafter an RTC) 15, a battery 16, an antenna 17, a communication section 18, an embedded controller/keyboard controller (hereinafter referred to as an EC/KBC) 19, an input device 20, a power source microcomputer 21 and a bus 22.

The CPU 11, the storage medium 12, the HDD 13, the RMA 14, the RTC 15, the communication section 18 and the EC/KBC 19 are connected to one another via the bus 22.

The CPU 11 is a control section configured to control an operation of the information terminal 1 and executes a BIOS stored in the storage medium 12. The CPU 11 also executes an OS stored in the HDD 13 and various application programs operating under the OS.

In the nonvolatile storage medium 12, the BIOS executed by the CPU 11 is stored. When the CPU 11 executes the BIOS, information about a date and time when a BIOS password is cleared and information about a date and time when a BIOS password is inputted are stored into the storage medium 12.

In the HDD 13, the OS executed by the CPU 11, the various applications and the like are stored. When the CPU 11 executes the OS, information about a date and time when the OS is logged into and information about a date and time when OS login is attempted is inputted are stored in the storage medium 12.

The RMA 14 is a temporary storage area, and the OS and the various application programs and the like stored in the HDD 13 are loaded into the RMA 14 when executed by the CPU 11.

The RTC 15 is a device configured to measure time, and manages time information and the like. Each section in the information terminal 1 operates with information about time measured by the RTC 15 as a reference.

The battery 16 is a battery which cannot be removed by a user and supplies a power source to the storage medium 12 and the RTC 15. Though the battery 16 is configured to supply a power source to the storage medium 12 and the RTC 15, a configuration is also possible in which batteries for the storage medium 12 and the RTC 15 are separately provided.

The antenna 17 performs transmission and reception of SMS's with the server 3.

The communication section 18 outputs an SMS received by the antenna 17, which is here a special SMS (special command) instructing the loss state settings to be described later, to the EC/KBC 19. The communication section 18 also transmits the loss state settings and a result notification in which information, such as the information about a date and time when OS login is performed in the information terminal 1 last, is recorded, to the server 3 via the antenna 17, the result notification being to be described later.

The EC/KBC 19 is a one-chip microcomputer in which an embedded controller for performing power management and a keyboard controller for controlling the input device 20 such as a keyboard are integrated. The EC/KBC 19 executes control to supply power from a battery or an AC adapter not shown to each section in cooperation with the power source microcomputer 21. When a special SMS is inputted from the communication section 18, the EC/KBC 19 supplies power from the battery not shown to each section of the information terminal 1 and causes the CPU 11 to execute the BIOS.

When the CPU 11 executes the BIOS, the loss state settings and the information, such as the information about a date and time when OS login is performed in the information terminal 1 last, is read from the storage medium 12 and result notification information in which each of the read information is recorded is transmitted to the server 3. Though the result notification information is transmitted to the server 3, the information may be transmitted, for example, to an address determined in advance or a server specified by a special SMS.

The input device 20 is a keyboard, a touchpad, a mouse or the like for inputting an operation instruction from the user.

The power source microcomputer 21 performs power source management of the information terminal 1 and performs control to supply commercial power from the AC adapter not shown to each section of the information terminal 1 or performs charge/discharge control of the battery not shown.

Next, a configuration for detecting that the HDD 13 has been removed from or inserted into the information terminal 1 will be described.

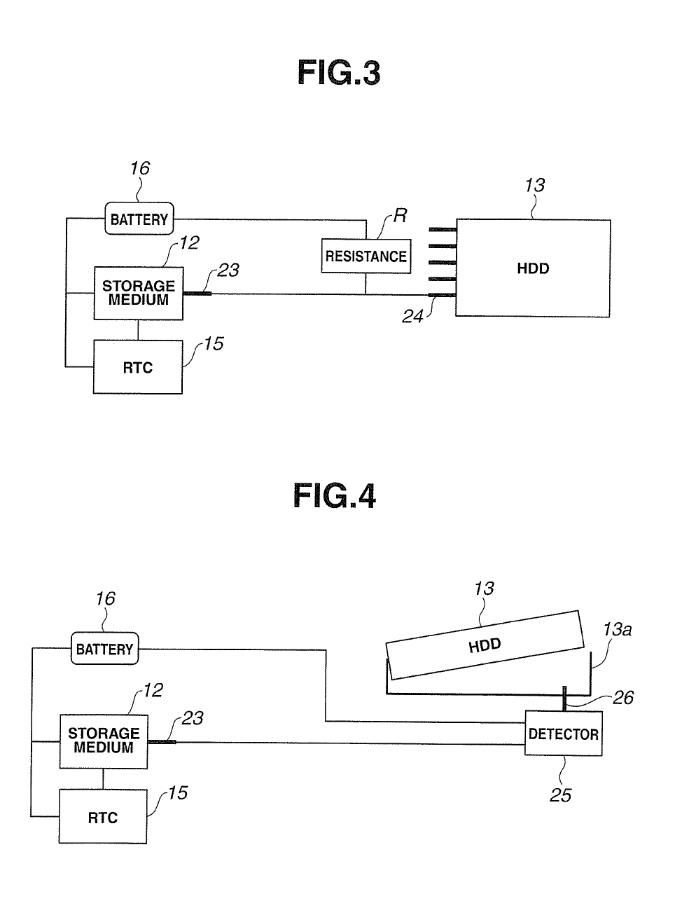

FIG. 3 is a diagram showing an example of the configuration for detecting removal/insertion of the HDD 13.

As shown in FIG. 3, the storage medium 12 has a detection terminal 23 configured to detect whether or not the HDD 13 has been removed/inserted. The HDD 13 has also multiple terminals, and a GND terminal 24, one of the multiple terminals, is connected to the detection terminal 23. Furthermore, each of the detection terminal 23 and the GND terminal 24 is connected to the battery 16 which cannot be removed/inserted by the user, via a resistance R.

Due to such a configuration, the detection terminal 23 detects an L-level signal when the HDD 13 is connected to the storage medium 12 and detects an H-level signal when the HDD 13 is not connected to the storage medium 12. Therefore, the detection terminal 23 detects signal level change from the L level to the H level when the HDD 13 is removed from the information terminal 1 and detects signal level change from the H level to the L level when the HDD 13 is inserted into the information terminal 1.

The storage medium 12 stores time when signal change is detected by the detection terminal 23 on the basis of time information from the RTC 15. Thereby, time when the HDD 13 is removed from or inserted into the information terminal 1 is stored in the storage medium 12.

FIG. 4 is a diagram showing an example of another configuration for detecting removal/insertion of the HDD 13. In FIG. 4, components similar to those in FIG. 3 are given same reference numerals, and description thereof will be omitted.

In the configuration of FIG. 4, the resistance R in FIG. 3 is deleted, and there are a detector 25 and a projection section 26 provided for the detector 25.

The projection section 26 is provided so as to project into an HDD case 13a in which the HDD 13 is contained. The projection section 26 is configured to push in the detector 25 when the HDD 13 is contained in the HDD case 13a and not to push in the detector 25 when the HDD 13 is not contained in the HDD case 13a.

The detector 25 detects whether or not the projection section 26 is pushed in, and outputs a detection signal to the detection terminal 23. For example, the detector 25 outputs an L-level signal to the detection terminal 23 when the projection section 26 is pushed in and outputs an H-level signal to the detection terminal 23 when the projection section 26 is not pushed in.

The other components are similar to those in FIG. 3, and the storage medium 12 stores time when the detection terminal 23 detects signal level change, that is, the time when the HDD 13 is removed from or inserted into the information terminal 1.

Next, an operation of the information terminal 1 configured as described above will be described.

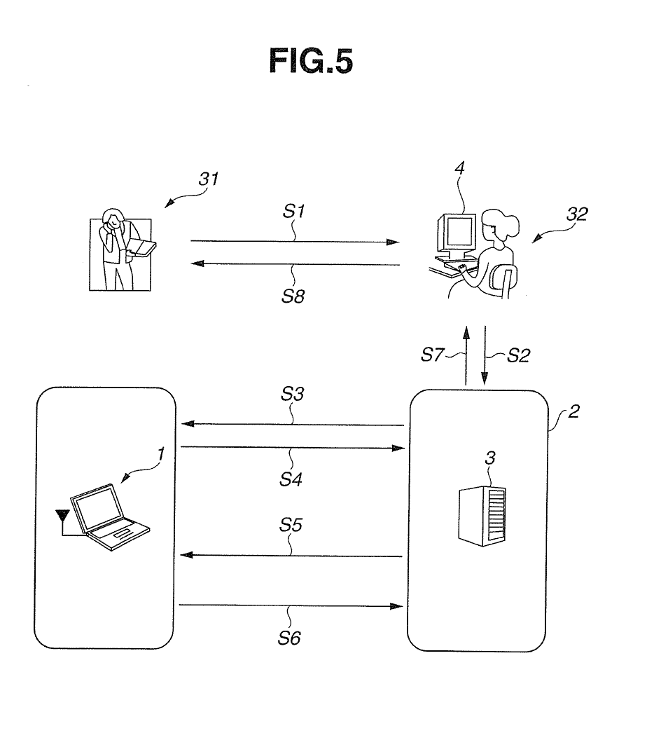

FIG. 5 is a diagram for illustrating the security management method using the information terminal 1.

First, an owner 31 who has lost the information terminal 1 informs an administrator 32 of a management company which provides services at the time of loss that he has lost the information terminal 1 (step S1). In this case, the administrator 32 asks the owner 31 about the loss state settings for the information terminal 1, for example, about whether the information terminal 1 is to be locked, data of the HDD 13 is to be deleted, or both of locking of the information terminal 1 and deletion of the data of the HDD 13 are to be performed. Then, the administrator 32 inputs information about the loss state settings requested by the owner 31, to the server 3 (step S2).

Next, the server 3 transmits a special SMS instructing the loss state settings to the lost information terminal 1 (step S3). In the case of being in a hibernation state (inactive state) or a shutdown state, the information terminal 1 which receives the special SMS executes the BIOS to be in an activated state. In the case of being in a suspend state, the information terminal 1 which receives the special SMS transitions to the hibernation state or the shutdown state and then executes the BIOS to be in the activated state. Furthermore, in the case of being in the activated state, the information terminal 1 which receives the special SMS keeps the activated state.

The information terminal 1 which has transitioned to the activated state connects to the connectable Internet 2 to access the server 3 and executes a request for connection to the server 3 (step S4). When connection with the information terminal 1 is established, the server 3 notifies the information about the loss state settings to the information terminal 1 (step S5). The information terminal 1 which receives the notification of the loss state settings responses to the notified loss state settings, that is, locks the information terminal 1, deletes the data of the HDD 13 or performs both of locking of the information terminal 1 and deletion of data of the HDD 13 here. Then, when the loss state setting process ends, the information terminal 1 makes a result notification (step S6).

In this case, the information terminal 1 reads out information about a date and time when OS login is performed last, information about a date and time when OS login is attempted last, information about a date and time when a BIOS password is cleared last, information about a date and time when a BIOS password is inputted last, information about a date and time when the HDD 13 is removed/inserted last, and information about a remaining battery level, which are stored in the storage medium 12, and notifies the information to the server 3 together with the result notification. Thereby, the information about the result of the loss state settings and the information such as the information about a date and time when OS login is performed are recorded in the server 3.

The administrator 32 obtains the result notification recorded in the server 3 (step S7). Then, the administrator 32 notifies the information about the date and time when the OS login is performed, the information about the date and time when the OS login is attempted, the information about the date and time when the BIOS password is cleared, the information about the date and time when the BIOS password is inputted, the information about the date and time when the HDD 13 is removed/inserted, and the information about the remaining battery level to the owner 31 of the information terminal 1 (step S8).

As described above, the information terminal 1 is configured to, when a special SMS instructing loss state settings is transmitted on the basis of a request by the owner 31 in the case of the owner 31 having lost the information terminal 1, write information about a date and time when OS login is performed last, information about a date and time when OS login is attempted last, information about a date and time when a BIOS password is cleared last, information about a date and time when a BIOS password is inputted last, information about a date and time when the HDD 13 is removed/inserted last, and information about a remaining battery level, into the server 3. The administrator 32 reads out each of the information written in the server 3 and notifies the read-out information to the owner 31 of the information terminal 1.

Thereby, the owner 31 of the information terminal 1 can recognize whether the BIOS password was broken or not and whether OS login was successful or not. Furthermore, the owner 31 of the information terminal 1 can recognize whether or not the HDD 13 has been removed from the information terminal 1. Furthermore, the owner 31 of the information terminal 1 can recognize how long the information terminal 1 can be activated, from the remaining battery level.

Thus, according to the information terminal 1 of the present embodiment, it is possible to, when the information terminal 1 is lost or stolen, easily recognize the state of the information terminal 1.

Furthermore, since the information indicating whether or not the HDD 13 has been removed from or inserted into the information terminal 1 is valuable information for judging whether or not confidential information has been leaked when the information terminal 1 is lost, notification of the state of the HDD 13, that is, the information indicating whether or not the HDD 13 has been removed from the information terminal 1 is a very useful service to the owner 31. Thus, the information terminal 1 can realize a more enhanced security management service.

While a certain embodiment has been described, the embodiment has been presented by way of example only, and is not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information terminal comprising:
a communication section configured to perform transmission and reception of data with a predetermined server via the Internet;
a nonvolatile storage medium configured to store information about a last date and time when an operating system is logged into; and
a control section configured to perform control to transmit the information about the last date and time when the operating system is logged into, which is stored in the nonvolatile storage medium, to the predetermined server via the Internet when the communication section receives a special command from the predetermined server.

2. The information terminal according to claim 1, wherein
the nonvolatile storage medium stores information about a last date and time when login to the operating system is attempted;
the control section performs control to transmit the information about the last date and time when the login to the operating system is attempted, which is stored in the nonvolatile storage medium, to the predetermined server via the Internet when the communication section receives a special command from the predetermined server.

3. The information terminal according to claim 1, wherein
the nonvolatile storage medium stores information about a last date and time when a BIOS password is cleared; and
the control section performs control to transmit the information about the last date and time when the BIOS password is cleared, which is stored in the nonvolatile storage medium, to the predetermined server via the Internet when the communication section receives a special command from the predetermined server.

4. The information terminal according to claim 1, wherein
the nonvolatile storage medium stores information about a last date and time when a BIOS password is inputted; and
the control section performs control to transmit the information about the last date and time when the BIOS password is inputted, which is stored in the nonvolatile storage medium, to the predetermined server via the Internet when the communication section receives a special command from the predetermined server.

5. The information terminal according to claim 1, wherein
the nonvolatile storage medium stores information about a last date and time when a hard disk drive is removed/inserted; and
the control section performs control to transmit the information about the last date and time when the hard disk drive is removed/inserted, which is stored in the nonvolatile storage medium, to the predetermined server via the Internet when the communication section receives a special command from the predetermined server.

6. The information terminal according to claim 1, wherein the control section performs control to transmit information about a remaining battery level to the predetermined server via the Internet when the communication section receives a special command from the predetermined server.

7. The information terminal according to claim 1, wherein the control to transmit the information to the predetermined sever via the Internet is executed by a BIOS.

8. A security management method in an information terminal provided with a communication section configured to perform transmission and reception of data with a predetermined server via the Internet, the method comprising:
storing information about a last date and time when an operating system is logged into, into a nonvolatile storage medium; and
performing control to transmit the information about the last date and time when the operating system is logged into, which is stored in the nonvolatile storage medium, to the predetermined server via the Internet when the communication section receives a special command from the predetermined server.

9. The security management method according to claim 8, further comprising:
storing information about a last date and time when login to the operating system is attempted, into the nonvolatile storage medium; and
performing control to transmit the information about the last date and time when the login to the operating system is attempted, which is stored in the nonvolatile storage medium, to the predetermined server via the Internet when the communication section receives a special command from the predetermined server.

10. The security management method according to claim 8, further comprising:
storing information about a last date and time when a BIOS password is cleared, into the nonvolatile storage medium; and
performing control to transmit the information about the last date and time when the BIOS password is cleared, which is stored in the nonvolatile storage medium, to the predetermined server via the Internet when the communication section receives a special command from the predetermined server.

11. The security management method according to claim 8, further comprising:
storing information about a last date and time when a BIOS password is inputted, into the nonvolatile storage medium; and
performing control to transmit the information about the last date and time when the BIOS password is inputted, which is stored in the nonvolatile storage medium, to the predetermined server via the Internet when the communication section receives a special command from the predetermined server.

12. The security management method according to claim 8, further comprising:
storing information about a last date and time when a hard disk drive is removed/inserted, into the nonvolatile storage medium; and
performing control to transmit the information about the last date and time when the hard disk drive is removed/inserted, which is stored in the nonvolatile storage medium, to the predetermined server via the Internet when the communication section receives a special command from the predetermined server.
